(19) United States
(12) Patent Application Publication
(10) Pub. No.: US 2022/0238014 A1
(43) Pub. Date: Jul. 28, 2022

(54) Vehicle Itself To Report Traffic Violations To The Traffic Police Department

(71) Applicant: Panasonic Automotive Systems Company of America, Division of Panasonic Corporation of North America, Peachtree City, GA (US)

(72) Inventor: AJAY RINGNE, Peachtree City, GA (US)

(21) Appl. No.: 17/561,788

(22) Filed: Dec. 24, 2021

Related U.S. Application Data
(60) Provisional application No. 63/141,095, filed on Jan. 25, 2021.

(51) Int. Cl. G08G 1/017; G08G 1/054; G08G 1/01

(52) U.S. Cl. CPC G08G 1/0175; G08G 1/0112; G08G 1/054

(57) ABSTRACT

A motor vehicle includes a first system detecting that the motor vehicle has violated a traffic law. A second system ascertains an identity of a person driving the motor vehicle during the violation of the traffic law. A wireless transmitter is communicatively coupled to the first system and to the second system. The wireless transmitter transmits a wireless signal indicative of the violation of the traffic law and the identity of the person driving the motor vehicle during the violation of the traffic law.

### CROSS-REFERENCED TO RELATED APPLICATIONS

This application claims benefit of U.S. Provisional Application No. 63/141,095, filed on Jan. 25, 2021, the disclosure of which is hereby incorporated by reference in its entirety for all purposes.

### BACKGROUND OF THE INVENTION

### 1. Field of the Invention

The present invention relates to a reporting system in a motor vehicle.

### 2. Description of the Related Art

Traffic violations committed by drivers are currently monitored by surveillance cameras and in-person by police officers. Cameras are expensive and difficult to install and maintain. Generally, drivers receive citations when a traffic rule is violated and the police are present at the time to see the violation. But violations go unnoticed if the police are not present the time of the violations.

### SUMMARY OF THE INVENTION

The invention may provide a motor vehicle that is capable of identifying and reporting its own traffic violations to the traffic police department by using over the air technology. The vehicle automatically detects certain traffic violations. Traffic police department can configure what violations should be reported by the vehicles. This could be global configuration applying to all vehicles, or the configuration may be different for different vehicles based on the vehicle type. For example, the police department may want to receive reports only when the vehicle is speeding excessively (e.g., above 100 mph). Examples of traffic violations that the vehicle can monitor and report are failing to stop at a stop sign or red light, speeding excessively, etc.

The invention comprises, in one form thereof, a motor vehicle including a sensor system detecting that the motor vehicle has violated a traffic law. A wireless transmitter is communicatively coupled to the sensor system. The wireless transmitter transmits a wireless signal indicative of the violation of the traffic law.

The invention comprises, in another form thereof, a monitoring method for a motor vehicle, including detecting within the motor vehicle that the motor vehicle has violated a traffic law. A wireless signal indicative of the violation of the traffic law is transmitted.

The invention comprises, in yet another form thereof, a motor vehicle including a first system (including necessary sensors) detecting that the motor vehicle has violated a traffic law. A second system (including necessary sensors) ascertains an identity of a person driving the motor vehicle during the violation of the traffic law. A wireless transmitter system is communicatively coupled to the first system and to the second system. The wireless transmitter system transmits a wireless signal with over the air technology indicative of the violation of the traffic law and the identity of the person driving the motor vehicle during the violation of the traffic law.

An advantage of the invention is that violations get reported immediately and with more certainty. Thus, motivation is provided for people to drive their vehicles with more caution and thereby reduce the number of accidents.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a vehicle traffic violation monitoring arrangement of the present invention.

FIG. 2 is a block diagram of one embodiment of the traffic violation monitoring system of the motor vehicle of FIG. 1.

FIG. 3 is a flow chart of one embodiment of a monitoring method of the present invention for a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

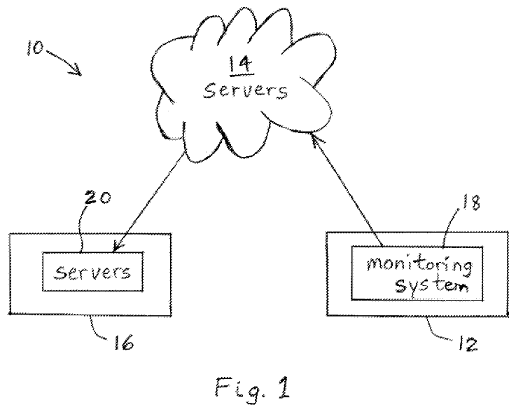

FIG. 1 illustrates one embodiment of a vehicle traffic violation monitoring arrangement 10 of the present invention, including a motor vehicle 12, one or more cloud computer servers 14, and a police station 16. Motor vehicle 12 includes a traffic violation monitoring system 18 that detects when vehicle 12 has been operated in violation of traffic laws, such as speed limits, requirements to stop at stop signs and red lights, etc. In response to detecting that vehicle 12 has been operated in violation of traffic laws, traffic violation monitoring system 18 wirelessly transmits a report of the violation to police station 16 via cloud computer servers 14. The report may include an identification of vehicle 12, such as a vehicle identification number and/or a license plate number. The report may include an identification of the driver at the time of the violation, which may be obtained by system 18 via facial recognition and/or fingerprint sensors, for example. The report may also include evidence and data related to the violation, such as vehicle speed data and/or video footage of vehicle 12 committing the violation.

Police station 16 includes computer servers 20 that wirelessly receive the reports from system 18 via servers 14. After receiving a report, servers 20 may issue a ticket or other notification of the traffic violation to the driver or the owner of vehicle 12. The ticket may include a fine that the driver must pay because of the violation. Servers 20 may also keep track of “points” or other records associated with violations that have been committed by the driver.

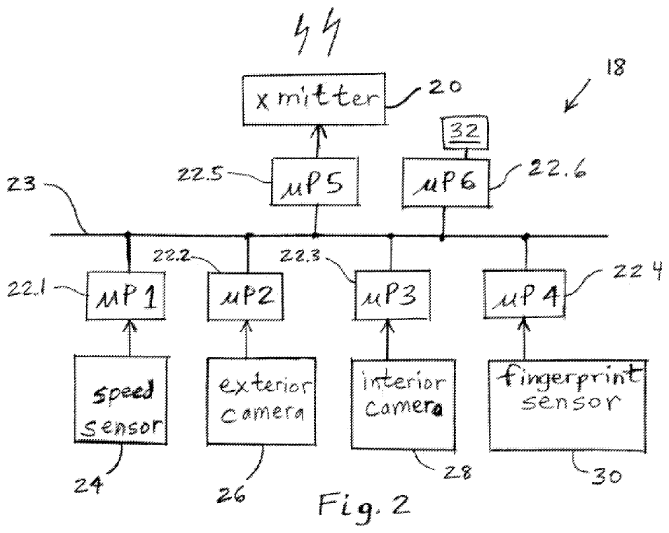

FIG. 2 illustrates one embodiment of traffic violation monitoring system 18 of motor vehicle 12, including a wireless transmitter 20, electronic processors 22.1, 22.2, 22.3, 22.4, 22.5, 22.6, a vehicle network 23, a vehicle speed sensor 24, an exterior camera 26, an interior camera 28, and a fingerprint sensor 30. Processor 22.6 may gather all information and decide whether there has been a violation of any traffic law. Although each sensor is shown as communicating with a respective processor, it is possible for a single processor to receive inputs from multiple sensors.

During use, the identity of the human driver is determined by facial recognition analysis of the images captured by interior camera 28 and/or by fingerprint sensor 30. As vehicle 12 is in motion, speed sensor 24 monitors the speed of vehicle 12, and processor 22.6 may compare this speed to the current speed limit, as determined by use of a GPS module 32, to ascertain whether vehicle 12 is exceeding the speed limit. Images captured by exterior camera 28 may be analyzed by processor 22.6 to determine whether vehicle 12 has committed a moving violation, such as failing to stop at a stop sign or a red light. Camera 28 may have a field of view that includes a scene in front of vehicle 12 so that images captured by camera 28 may include stop signs and traffic lights approached by vehicle 12. Processor 22.6 may also receive signals from roadside infrastructure (not shown) to determine when vehicle 12 is approaching a stop sign or red light. Signals from GPS module 32 may also be used to ascertain if vehicle 12 is approaching the known location (e.g., from a database) of a stop sign or traffic light.

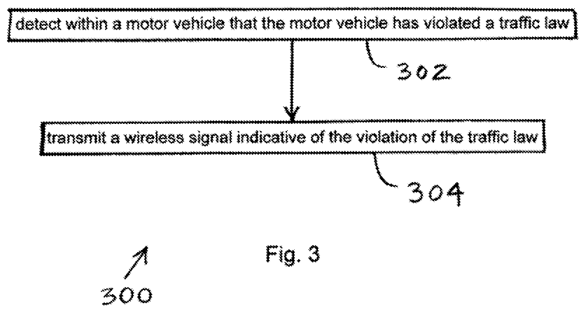

FIG. 3 illustrates one embodiment of a monitoring method 300 of the present invention for a motor vehicle. In a first step 302, it is detected within the motor vehicle that the motor vehicle has violated a traffic law. For example, images captured by exterior camera 28 may be analyzed by processor 22.6 to determine whether vehicle 12 has committed a moving violation, such as driving through a red light.

In a final step 304, a wireless signal is transmitted that is indicative of the violation of the traffic law. For example, in response to detecting that vehicle 12 has been operated in violation of traffic laws, traffic violation monitoring system 18 may wirelessly transmit a report of the violation to police station 16 via cloud computer servers 14.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A motor vehicle, comprising:
a sensor system configured to detect that the motor vehicle has violated a traffic law; and
a wireless transmitter system communicatively coupled to the sensor system, the wireless transmitter being configured to transmit a wireless signal indicative of the violation of the traffic law.

2. The motor vehicle of claim 1 wherein the sensor system includes a vehicle speed sensor.

3. The motor vehicle of claim 1 wherein the sensor system includes a camera configured to capture images of a scene in front of the motor vehicle.

4. The motor vehicle of claim 1 wherein the sensor system includes a sensor configured to detect the motor vehicle exceeding a speed limit.

5. The motor vehicle of claim 1 wherein the sensor system includes a sensor configured to detect the motor vehicle failing to stop at a stop sign or a red traffic light.

6. The motor vehicle of claim 1 wherein the wireless signal identifies the motor vehicle.

7. The motor vehicle of claim 1 wherein the wireless signal identifies a person who was driving the motor vehicle during the violation of the traffic law.

8. A monitoring method for a motor vehicle, the method comprising:
detecting within the motor vehicle that the motor vehicle has violated a traffic law; and
transmitting a wireless signal indicative of the violation of the traffic law.

9. The method of claim 8 wherein the detecting is performed by use of a vehicle speed sensor.

10. The method of claim 8 wherein the detecting includes capturing images of a scene in front of the motor vehicle.

11. The method of claim 8 wherein the detecting includes ascertaining that the motor vehicle is exceeding a speed limit.

12. The method of claim 8 wherein the detecting includes sensing that the motor vehicle has failed to stop at a stop sign or a red traffic light.

13. The method of claim 8 wherein the wireless signal identifies the motor vehicle.

14. The method of claim 8 wherein the wireless signal identifies a person who was driving the motor vehicle during the violation of the traffic law.

15. A motor vehicle, comprising:
a first system configured to detect that the motor vehicle has violated a traffic law;
a second system configured to ascertain an identity of a person driving the motor vehicle during the violation of the traffic law; and
a wireless transmitter system communicatively coupled to the first system and to the second system, the wireless transmitter being configured to transmit a wireless signal indicative of the violation of the traffic law and the identity of the person driving the motor vehicle during the violation of the traffic law.

16. The motor vehicle of claim 15 wherein the first system includes a vehicle speed sensor.

17. The motor vehicle of claim 15 wherein the first system includes a camera configured to capture images of a scene in front of the motor vehicle.

18. The motor vehicle of claim 15 wherein the first system includes a sensor configured to detect the motor vehicle exceeding a speed limit.

19. The motor vehicle of claim 15 wherein the second system includes a camera configured to capture images of the person driving the motor vehicle during the violation of the traffic law.

20. The motor vehicle of claim 15 wherein the second system includes a fingerprint sensor.
